(19) United States
(12) Patent Application Publication
(10) Pub. No.: US 2008/0138674 A1
(43) Pub. Date: Jun. 12, 2008

(54) Hydrogen powered vehicle fueling via a pneumatic transfer of a solid state hydrogen carrier

(76) Inventors: Guido Peter Pez, Allentown, PA (US); Thomas Claude Noll, Emmaus, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/636,098

(22) Filed: Dec. 8, 2006

(51) Int. Cl. H01M 8/04; B67D 5/00

(52) U.S. Cl. 429/17; 222/4

(57) ABSTRACT

Apparatus and methods are provided for fuelling a hydrogen-powered vehicle directly with a solid-state particulate carrier material those functions as a reversible hydrogen carrier. The material is delivered to the vehicle from a filling station via pneumatic transfer in a carrier fluid. Such as a hydrogen gas or an inert gas. Following removal of hydrogen from the carrier material to form an at least partially dehydrogenated carrier, a second re-fuelling mode of operation removed the hydrogen-depleted carrier from the vehicle's fuel storage vessel and pneumatically transfers it back to the filling station, where it can be subsequently rehydrogenated.

### CROSS-REFERENCE TO RELATED APPLICATIONS

The subject matter of the instant invention is related to U.S. Pat. Nos. 6,596,055; 7,101,530, U.S. patent application Ser. No. 10/833.484, filed on Apr. 27, 2004, Ser. No. 11/266,803, filed on Nov. 04, 2005, Ser. No. 11/398961, filed on Apr. 06, 2006; Ser. No. 11/398965, filed on Apr. 06, 2006, Ser. No. 11/398960, filed on Apr. 06, 2006, Ser. No. 11/437110, filed on May 18, 2006, and Ser. No. 10/724848, filed on Dec. 01, 2003. The disclosure of the previously identified patents and patent applications is hereby incorporated by reference.

### BACKGROUND OF THE INVENTION

The instant invention relates to apoparatus and methods for fuelling a hydrogen powered vehicle directly with a solid material that functions as a reversible hydrogen carrier. The material is delivered to the vehicle from a filling station via pneumatic transfer in a carrier fluid. In the corresponding re-fuelling operation the now hydrogen-depleted carrier is extracted from the vehicle's fuel tank and pneumatically transferred back to the filling station where it is re-loaded with hydrogen.

By way of background example, hydrogen-based fuel cells are viewed as a replacement for conventional means of generating electricity, and hydrogen is also viewed as potential fuel substitution for conventional internal combustion engines (ICE). While such hydrogen-based systems are desirable, hydrogen supply, delivery, and storage may provide a number of technical challenges. For example, a typical hydrogen delivery truck carries hydrogen at low cryogenic temperature. In an alternative method, hydrogen can be stored as a compressed gas. Another alternative comprises hydrogen stored on a solid carrier sorbent, for example, solid state metal hydride sorbents.

The sorption and release of hydrogen by a reversible solid carrier (such as a metal hydride) is necessarily accompanied by significant heat changes. In the fuelling and re-fuelling of a hydrogen-powered vehicle where the admitted hydrogen is stored in a tank containing the solid carrier, the exothermic H₂-sorption process together with a tank containing the solid carrier, the exothermic H₂-sorption process together with relatively short (several minute) fill times typically requires the design of engineering systems which can handle the relatively large required heat transfer rates. Conventional cooling systems employing forced air, cooling water or refrigeration are too large and/or too costly to be practical. There remains a need in this art for apparatus and methods that solve or mitigate the heat transfer challenges presented by use of solid carrier sorbents to store and release hydrogen.

The problem of dealing with the heat evolved in the course of fuelling a hydrogen vehicle is discussed in PCT publication WO2006035765-A1 (hereby incorporated by reference), which suggests that cooling of heat generated by the exothermic charging of hydrogen into a carrier may be effected using the vehicle's radiator, with the desired heat transfer augmented by an external cooling fan. However, it is believed that the use of such a radiator system would provide only a fraction of the cooling required to permit refueling of a carrier within the industry targeted time of less than about 3 minutes, as further described herein.

There is a continuing need in this art for apparatus and methods of providing hydrogen fuel product for use fuel cells, internal combustion engines, and other consumption devices in a safe, efficient and cost-effective manner. There is also a need in this art for methods that provide a simple, efficient, and safe fuel refilling transaction that can be implemented by all product customer groups, including but not limited to vehicle operators, power generators, filling stations, carrier owners, product owners, product generators, product users, fresh/spent and product distribution sites, and other users.

### BRIEF SUMMARY OF THE INVENTION

The present invention describes a novel process by which a solid carrier that functions as a reversible hydrogen carrier is loaded into, and off-loaded from, a fuel storage tank or vessel as a means to provide a gaseous hydrogen fuel source for motor vehicle usage. The invention is applicable to automobiles, trucks, and other motorized vehicles, as well as any hydrogen powered system. The described process comprises both apparatus and methods to pneumatically fill and empty a fuel storage vessel with a solid-state hydrogen carrier via a dense-phase, dilute-phase, and combinations of dense-phase and dilute-phase pneumatic transport.

Additionally, a unique rehydrogenator design is described that serves to replenish the hydrogen-depleted solid-state carrier thereby allowing multiple reuses of the solid-state carrier for hydrogen fueling purposes. The rehydrogenator design, being integral with the pneumatic transferring systems, provides an efficient, closed-loop process for filling, off-loading and rehydrogenating the solid-state carrier.

In one embodiment, the invention provides apparatus and methods for charging a solid-state sorbent with hydrogen, and for dispensing the hydrogen-charged solid-state sorbent to a user, for example, to a hydrogen powered vehicle. In this embodiment, fuelling the vehicle is achieved, not with gaseous hydrogen, but with the already hydrogen-loaded solid-state sorbent carrier. The hydrogen “loaded” and hydrogen “unloaded” carrier is respectively transported to and from the vehicle via pneumatic transfer processes.

In yet another embodiment, the invention provides apparatus and methods to control and manage the heat transfer rate associated with a storage of hydrogen by a sorbent carrier material in operations involving fuelling and refueling of a hydrogen powered vehicle.

The present invention further describes processes by which a solid that functions as a reversible hydrogen carrier is loaded into and off-loaded from a fuel storage tank or vessel as a means to provide a gaseous hydrogen fuel source for motor vehicle usage. The invention is applicable to automobiles, trucks, and other motorized vehicles, any hydrogen powered mobile systems. The described process comprises both devices and methods required to pneumatically fill and empty a fuel storage vessel with a solid-state hydrogen carrier via a combination of both dense-phase and dilute-phase pneumatic transport.

Additionally, a unique rehydrogenator design is described that serves to replenish the hydrogen-depleted solid-state carrier thereby allowing multiple reuses of the solid-state carrier for hydrogen fueling purposes. The rehydrogenator design, being integral with the pneumatic transferring systems, provides an efficient, closed-loop process for filling, off-loading and rehydrogenating the solid-state carrier.

Other features and advantages of the present invention will be apparent from the following more detailed description of certain embodiments, taken in conjunction with the accompanying drawings which illustrate, by way of example, the principles of the invention.

### BRIEF DESCRIPTION OF SEVERAL VIEWS OF THE DRAWINGS

FIG. 1 is a schematic of an exemplary hydrogen sorption/desorption isotherm for an exemplary microporous hydrogen sorbent.

FIG. 2 is a schematic of an exemplary pressure-composition isotherm for an exemplary binary metal hydride.

FIG. 3 is a schematic for loading fresh fuel comprising a H₂-loaded hydrogen carrier into a vehicle illustrating the apparatus and methods in accordance with one embodiment of the present invention.

FIG. 4 is a schematic for off-loading of spent fuel in the form of depleted hydrogen carrier solid from a vehicle's fuel tank illustrating the apparatus and methods in accordance with one embodiment of the present invention.

FIG. 5 is a schematic for a fluidized-bed re-hydrogenation reactor illustrating the apparatus and methods in accordance with one embodiment of the present invention.

FIG. 6 is a schematic for a fresh solid-state carrier feed arrangement illustrating the apparatus and methods in accordance with one embodiment of the present invention.

FIG. 7 is a schematic for an exemplary vehicle storage vessel illustrating the apparatus in accordance with one embodiment of the present invention.

### DETAILED DESCRIPTION OF THE INVENTION

The storage of hydrogen on board mobile systems, from passenger vehicles to large transports is a well recognized challenge in the context of a hydrogen fuelled economy. Criteria for an energy storage and space efficient vehicular storage of hydrogen are provided in “Technical Targets”, Section 3.3.4.1 of the DOE's Hydrogen Fuel Cells Infrastructure Technologies Multi-Year Research, Development and Demonstration Plan. The challenging gravimetric and volumetric energy density targets for the stored hydrogen that are provided in the Plan (i.e., of a 6 wt % and 45 g/L for 2010), have been the principal focus of much research. However, the “System Fill Time” i.e., the vehicle refueling time criteria for years 2010 and 2015 of 3 min and 2.5 min respectively, which can impose engineering challenges, depending on the nature of the storage system employed have received relatively less attention.

Options for on-board hydrogen storage include: (a) Hydrogen as a high pressure compressed gas, (b) Hydrogen as contained in a pressure, temperature, or pressure and temperature reversible solid state sorbent, (c) Liquid hydrogen at cryogenic temperatures. On-board reforming of gasoline, methanol and other hydrocarbon fuels are other routes for indirectly providing a source of hydrogen to a fuel cell or internal combustion engine in a vehicle.

The reversible hydrogen storage option (b) implies the existence of an equilibrium between H₂ (gas) and the solid sorbent:

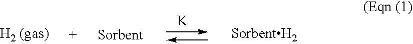

Regardless of the nature of the sorbent, a “capture” of hydrogen gas into a bound form will always be accompanied by a release of heat, which amounts to a loss of heat (i.e. −ΔH [Sorption]) of heat by the system. Fundamentally, this heat change arises from the loss of entropy −ΔS (Sorption) of hydrogen gas as it passes from the free gaseous form to a more physically constrained bound state in the sorbent. The heat, ΔH entropy, ΔS changes and equilibrium constant K for equation 1 are related by the fundamental thermodynamic equations:

ΔG=−RTInK=ΔH−TΔS Eqn (2)

where K is the equilibrium constant for the reaction,

$$i . e . K = \frac{[ Sorbent \cdot {H}_{2} ]}{[ {P}_{{H}_{2}} ] [ Sorbent ]} \qquad Eqn ( 3 )$$

where P_{H}_{₂} is the partial pressure of hydrogen and ΔG in the free energy change.

For a favorable H₂ sorption to occur, ΔG (Sorption) will be a small or negative number. The entropy change ΔS is expected to be between 30 cal/deg.mole (essentially the ΔS° for free H₂) to about 20 cal/deg.mole. Thus, for example, where ΔG=0 at 300K for this range of ΔS values, correspondingly a ΔH (Sorption), an exotherm of from −9 to −6 kcal/mole H₂ will result. An equivalent amount of heat input (ΔH (Desorption)) would be needed to release the hydrogen from the sorbent.

It is, therefore, clear that there are significant heat changes associated in the capture (storage) and release of hydrogen from its bound state in a sorbent. These heat changes have to be accommodated in the engineering design of the hydrogen storage and release systems. A particular problem is posed by the release of heat or exotherm (−ΔH (sorption)) that would necessarily accompany a sorption of H₂ by an on-board carrier during refueling over a short time period. For example, loading 5 Kg H₂ into a sorbent with a −ΔH (sorption) of only 6 kcal/mole H₂, in 3 minutes corresponds to a mean heat-transfer rate of about 350 kW. This may be compared to the 75 kW power of the vehicles' driving engine. The former quantity therefore represents a relatively large heat thermal transfer rate, heat that somehow has to be dissipated during the fuelling or refueling operation. In contrast, for a consumption of the 5 Kg of H₂ over a period of 3 hours of driving, the rate is now an acceptable 5.8 kW. For hydrogen fuelling and re-fuelling conventional means of cooling, such as by the use of cooling water or refrigeration fluids are considered impractical because of this required large heat transfer rate.

It is known to use metal hydride slurries to enable absorption, pumping and delivery of pure hydrogen. See, for example, P. J. T. Bussman et al in Polytechnish Tijdschrift, Procestechniek (Netherlands) 46 (4) p. 64-68 Ap. 1991. In an abstract from W.PIM. van Swaaij et al of apparently related Dutch work, the system studied is a lanthanum nickel hydride (LaNiH₅)—silicone oil slurry, wherein the transport carrier for the metal hydride is silicone oil—an involatile liquid. These known metal hydride/oil slurry technologies have at least two major drawbacks: (a) The H₂ storage capacity reduction by the oil carrier and (b) it is incompatible with microporous H₂ sorbents where an oil film on the carrier's surface would preclude an adsorption of the hydrogen. The present invention is desirable over such slurries because it provides apparatus and methods for transferring H₂-loaded metal hydrides to a user vehicle in a usable, dry state (i.e. via gaseous versus oil or silicone liquids) through fluidized pneumatic transfer equipment and processes. The inventive pneumatic transfer processes require the carrier solid to be in a fluidized state i.e. suspended as fine particles in a carrier gas, which may (depending on the hydrogen dissociation pressure of the carrier) be either an inert gas or hydrogen.

A significant barrier to use of solid-state hydrogen storing sorbents as carriers is the substantial exothermic release that is a consequence of the containment of hydrogen by the sorbent. While by the choice of the sorbent material the exotherm may be minimized within limits (see above) even with minimal values of −ΔH (sorption), the heat transfer rates become difficult to manage, such as where a fast H₂ loading over several minutes of refueling is needed. However, if the H₂ loading process were effectively carried out over much longer times, the required heat dissipation rate would then be far more manageable. The present invention provides apparatus and methods wherein a bulk quantity of the sorbent is “loaded” with hydrogen at the fuelling station at a much lower rate (wt H₂/unit time) with correspondingly lower heat transfer duties. In addition, heat management is easier because it can be performed entirely at the filling station. Once loaded with H₂, loaded sorbent can be transferred to the vehicle, thus by-passing the heat transfer problem at the vehicle that would otherwise be encountered such as in a direct fuelling or refueling of the vehicle with gaseous hydrogen.

The present invention further provides advantages with respect to management of sorbents, hydrogen, and heat. For example, a filling station which services, for example, 10 vehicles an hour delivering over a 3-minute period 5 Kg H₂ per vehicle over a 12-hour work day would require a daily (24 hour) inventory of (12×5×10)=600 Kg H2. With a ΔH of −6 kcal/mole of H₂ this corresponds to an average heat transfer rate over the 24 hour period of 87.5 kW, about one-quarter of that of the 3-minute individual vehicle fill. The following exemplary calculations support our conclusions:
(a) For 600 Kg H₂ over 24 hours

$$\begin{matrix}= \frac{600 \times {10}^{3} g {H}_{2}}{24 hour} \times \frac{6 k cal}{mole {H}_{2}} \times \frac{mole {H}_{2}}{2 g {H}_{2}} \times \frac{4.2 k J}{k cal} \times \frac{hour}{3 \text{,} 600 sec} \\ = 87.5 kJ \text{/} sec \\ ≡ 87.5 kW\end{matrix}$$

(b) For 5 Kg H₂ over 3 min.:

$$\begin{matrix}= \frac{5 \times {10}^{3} {gH}_{2}}{3 min} \times \frac{6 k cal}{mole {H}_{2}} \times \frac{mole {H}_{2}}{2 g {H}_{2}} \times \frac{4.2 k J}{k cal} \times \frac{min}{60 sec} \\ = 350 kJ \text{/} sec \\ ≡ 350 kW\end{matrix}$$

Thus, 87.5 kW would be the required heat transfer rate for a re-charging of the depleted sorbent (hydrogen carrier) in a continuous process over 24 hours at the filling station. Again, there is the advantage of not only the lower continuous (no peak demand) heat transfer rate, but also it is expected that the engineering and operation of an appropriate heat transfer system will greatly benefit from the larger surface area of a filling station rather than that available on a vehicle.

This envisaged transfer of the H₂-loaded carrier from the filling station to the vehicle for fuelling or refueling and the return of the H₂-depleted solid state carrier to the station may be accomplished by the inventive pneumatic transport process. A particulate solid carrier is contacted with a flowing gas stream that transforms the solid carrier into a fluidized form. For example, the particulate solid carrier may be a microporous hydrogen sorbent material, a metal alloy hydride, a complex metal hydride, or a combination thereof. Depending on the H₂ dissociation pressure of the solid carrier, the fluidizing medium may be either hydrogen or an inert gas such as argon. In the fluidized state the carrier is transported in the flowing gas stream from the filling station to the vehicle's fuel tank. Subsequently, when the carrier has been depleted of its contained hydrogen, such as by a dehydrogenator of the vehicle, the carrier can likewise be removed from the vehicle and returned to the filling station for re-hydrogenation. A fuller description of such a two-way transfer of the solid state hydrogen carrier is provided herein.

### Hydrogen Carrier Solids.

In one example of the present invention, the hydrogen carrier is a particulate solid that can reversibly sorb hydrogen. For example, the particulate solid carrier may be a microporous hydrogen sorbent material, a metal alloy hydride, a complex metal hydride, or a combination thereof. As described by the equations above, the uptake (sorption) and release (desorption) of hydrogen by the solid is a process for which at equilibrium, the hydrogen loading on the sorbent [Sorbent H₂] is a function of both temperature and hydrogen pressure. At near ambient temperatures this equilibrium hydrogen pressure, pH₂ can vary widely, depending on the physical and/or chemical characteristics of the solid carrier which determine its interaction with hydrogen. This pH₂, alternatively designated as the hydrogen dissociation pressure of the carrier is a useful factor in the design of the pneumatic transfer process since it can dictate the choice of carrier fluid (carrier gas) for any particular carrier. The partial pressure of hydrogen in the pneumatic transfer fluid is normally at least equal to or higher than the carrier's hydrogen dissociation pressure at the temperature of the mobile solid/fluid (e.g., otherwise there may be a loss of bound hydrogen). At very low values of pH₂ or where the H₂ desorption kinetics at pneumatic transfer temperatures is relatively slow the carrier fluid may be an inert gas, such as nitrogen or argon, for example. In some pneumatic transfer situations, a combination of hydrogen and nitrogen or hydrogen and argon may be useful.

Without wishing to be limited by any theory or explanation, it is contemplated that hydrogen may be reversibly contained in appropriate sorbent materials by either a physisorption mechanism—where the H₂ molecule is adsorbed intact on a surface, or via a chemisorption process where the hydrogen is dissociated and it bound to the solid as hydrogen atoms. Generally speaking, physisorbed hydrogen is relatively weakly bound thus requiring high pressures for adequate loading. Chemisorbed hydrogen, on the other hand, is associated with tighter binding, lower hydrogen dissociation pressures—and consequently (as shown in Equation 2) higher heats of sorption (ΔH sorption).

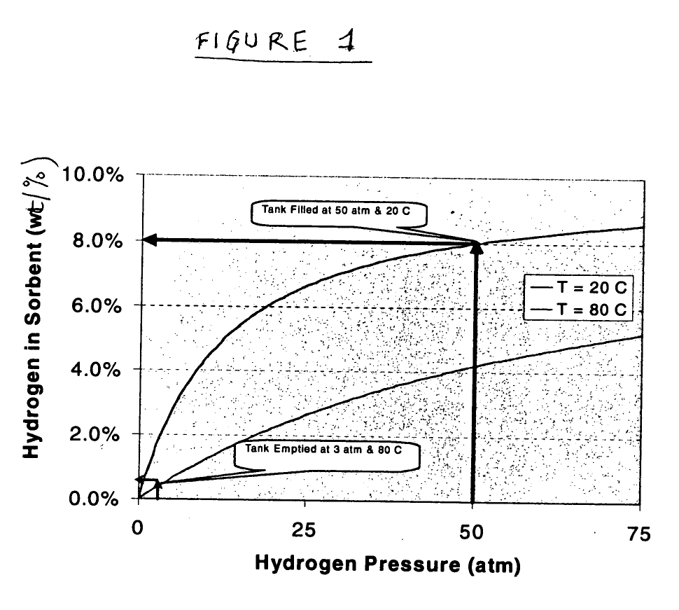

Microporous materials such as activated carbons, potassium-intercalated graphite (eg. C₂₄K), carbon nanotubes, metal organic framework (MOF) compositions, and less commonly, zeolites and cyanometallates can function as “physical” H₂ adsorbents. The adsorption and desorption of H₂ in microporous solids is usually represented by a Langmuir-type isotherm, as shown in FIG. 1. Here an exemplary model sorbent's H₂ capacity (wt % H₂) is plotted against equilibrium hydrogen pressure. Isotherms are provided for two temperatures. The sorbent is “loaded” to a 8 wt % H₂ content at 50 atm at the filling station and while still under this pressure of hydrogen it is conveyed by pneumatic transfer to the vehicle's fuel storage tank. Discharge of H₂ during operation of the vehicle takes place between 50 and 3 atm at 20° C. to 80° C.

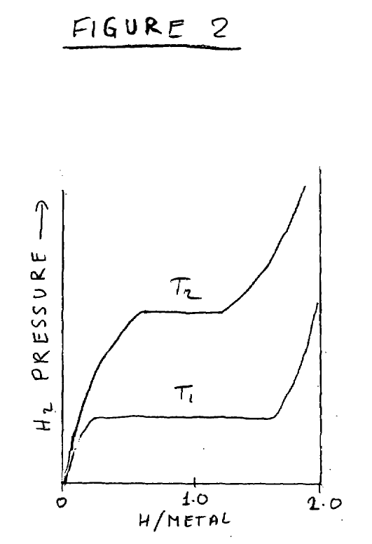

Metal alloy hydrides constitute examples of a chemisorbed hydrogen where upon reaction with the metal alloy hydrogen dissociates into H atoms forming a metal hydride solid structure. Exemplary schematic pressure-composition isotherms for a metal-hydride or a metal alloy hydride are shown in FIG. 2. Here the hydrogen pressure is plotted against (as an example) a binary hydride MH₂ (M:H=1:2). At low H₂ pressure hydrogen dissolves in the alloy; in the plateau region the metal (or alloy) and metal hydride co-exist in equilibrium and after that there is a steep increase in H₂ pressure which is required to achieve full stoichiometry. The pressure at the plateau region is the dissociation pressure of the metal or metal-alloy hydride which in the pneumatic transfer process has to be equal to or superseded by the partial pressure of hydrogen in the pneumatic transfer fluid. Examples of metal and metal alloy hydrides with their H₂ dissociation pressures are: LaNi₅H (1.8 atm H₂, 25° C.), TiFe_{0.8}Ni_{0.2}H_{0.7} (0.1 atm H₂, 25° C.), MgH₂ (1 atm, 290° C.).

Hydrogen can also be chemisorbed resulting in the formation of “complex hydrides”. These are solid state ionic structures usually consisting of a light metal cation (i.e. Na⁺Li⁺ and an anion which contains one or more hydrogens bound to a central atom. An example is sodium aluminum hydride, NaAlH₄ which can be made by the reaction of sodium hydride with aluminum metal and at appropriate temperatures and H₂ pressures is reversible in hydrogen. In many cases complex hydrides have very low H₂ dissociation pressures which provides the option of performing the pneumatic transfer with the use of only an inert gas.

### Dense Phase and Dilute Phase Pneumatic Transport.

This invention utilizes the technologies of “Dense-phase pneumatic transport” and “Dilute-phase pneumatic transport.” Both technologies are effective for the conveyance of particulate solids. The methodologies of each technology are further described herein and in the cited references.

“Dense-phase pneumatic transport system” as prescribed within this invention encompasses the entire range of solids conveying systems that are typically characterized by high solids to gas loadings, low gas velocities and relatively high pressure losses. These systems are generally classified by the following three broad categories: a) simple pressure, b) pulse phase, and c) bypass systems, but are not limited to such. See, e.g. Konrad, K., “Dense-Phase Pneumatic Conveying: A Review”, Powder Technology, 49 pp. 1-35 (1986), and S. M. Wolas “Chemical Process Equipment Selection and Design” Butterworth-Heineman Series 1990 in Chemical Engineering Sec. 5 “Transferred Solids” p 69.

“Dilute-phase conveying system” as prescribed within this invention encompasses all pneumatic solids transport systems characterized by low solids to gas loadings, high gas velocities, and relatively low pressure losses. These systems typically operate in one of the following modes: a) positive pressure, b) negative pressure, or c) a combined negative/positive pressure system. See, e.g., Cheremisinoff, N., et. al., “Hydrodynamics of Gas-Solids Fluidization”, Gulf Publishing Company, Houston, Tex., pp. 543-570 (1984). Maynard, E., “Designing Pneumatic Conveying Systems”, Chemical Engineering Progress, 102(5), pp. 23-33 (May 2006).

### Description of Fuelling, Refueling and Carrier Rehydrogenation Processes.

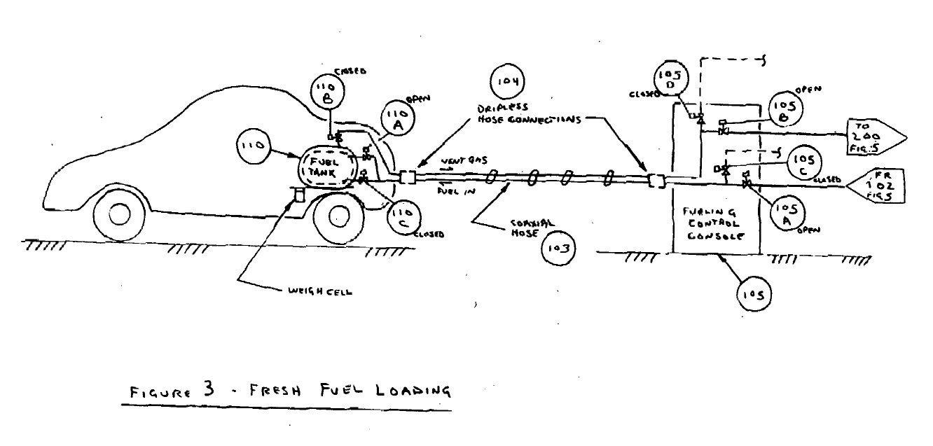

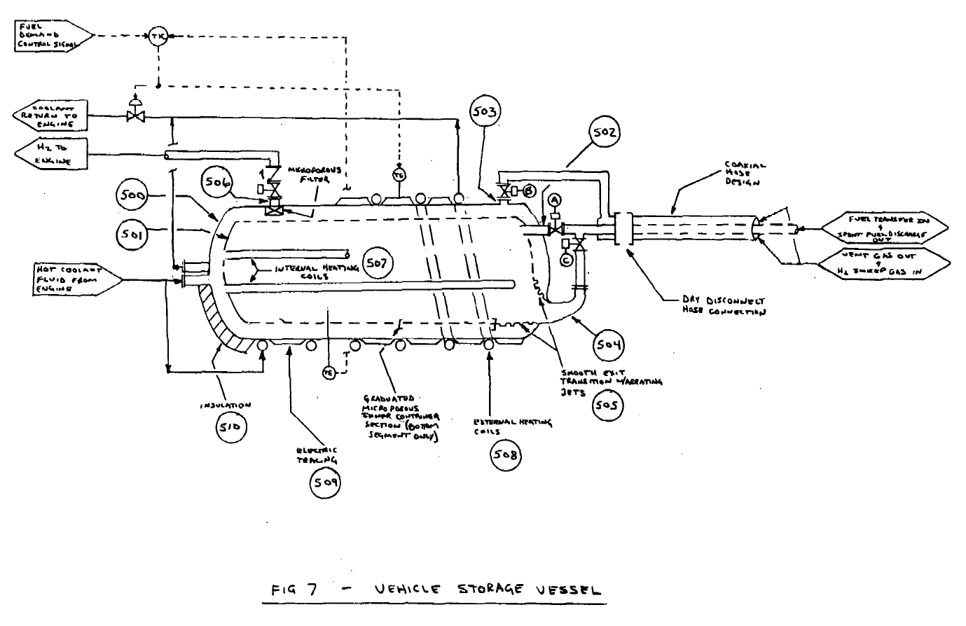

The invention will now be described by delineating apparatus and methods using the example of three primary operating modes, as shown in FIGS. 3 through 6. The three operating modes include: the refueling process, the spent fuel carrier off-loading process, and the solid-state carrier rehydrogenation process. An exemplary vehicle fuel storage vessel design and configuration is illustrated separately in FIG. 7, and is separately discussed herein. These Figures illustrate certain aspects of the invention and do not limit the scope of the claims appended hereto.

### Example of Fresh Fuel Loading.

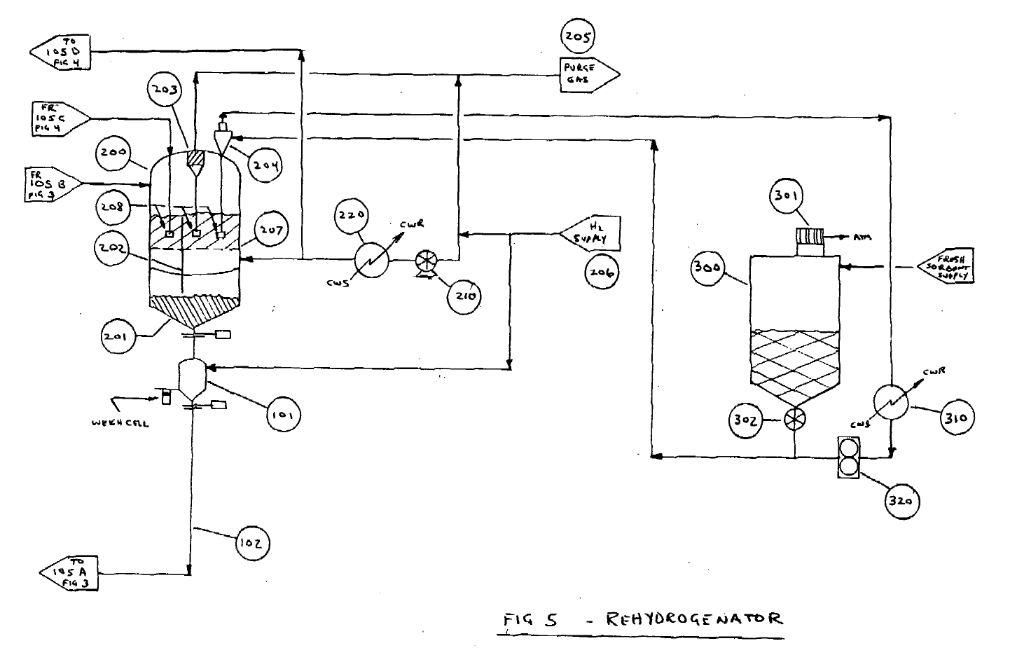

As illustrated in FIG. 3 and FIG. 5, a solid-state hydrogen carrier material containing about 6 weight % to about 12 weight % hydrogen with a typical particle size distribution ranging from about 200 microns to about 500 microns, but not limited to such, is pneumatically conveyed from the rehydrogenator storage vessel 201 to the vehicle fuel storage vessel 110 via a dense-phase conveying system, such as a dense-phase pneumatic transport. The dense-phase transport vessel 101 is used to both pressurize and partially fluidize the carrier solids thereby enabling the solid carrier to discharge into the conveying line 102. However, other suitable vessels and techniques may be used to discharge the carrier solids from the hydrogenator into the dense-phase transport system, such as, but not limited to: a) single or double pressurized hopper arrangement with or without aeration capability, b) pressurized hopper discharge controlled via air knife or slide-gate valve, c) rotary airlock valve (star valve), and d) screw feeder designs. Additional information concerning such systems is described in the following publications: by Maynard, E., “Designing Pneumatic Conveying Systems”, Chemical Engineering Progress, 102(5), pp. 23-33 (May 2006); and, Walas, S., “Chemical Process Equipment—Selection and Design”, Butterworth-Heinemann Series in Chemical Engineering, Reed Publishing, USA, pp. 69-76 (1990) which publications are hereby incorporated herein by reference as though fully set forth herein.

The dense-phase conveying system transports the hydrogen-laden solid carrier at relatively low velocities in the range of about 0.5 m/sec to about 2 m/sec with conveying gas supplied to the transport vessel 101 at pressures ranging from about 2 barg to about 5 barg. Hydrogen or suitable inert gas (e.g., argon) is used as the conveying gas and provides the necessary motive force for solids transport. The low pipe velocity afforded by dense-phase solids pneumatic transport results in minimal solids attrition during conveying as well as lower solid particle heat generation resulting from particle-to-pipewall and particle-to-particle frictional effects. Consequently, any thermally induced desorption of hydrogen from the solid-state carrier that may be caused by these frictional effects is minimized.

As shown in FIG. 3, a conveying connection is provided in the form of a pneumatic conveying line between the fueling control console 105 and the vehicle's fuel storage vessel inlet connection. While the conveying connection can be of any type of flexible closed-wall hosing or piping, the conveying connection can be a flexible coaxial fuel hose 103. If desired, the fuel hose 103 is fitted with a dripless hose end-coupling 104, and extends as a pneumatic conveying line from a fueling control console 105 to the vehicle's fuel storage vessel inlet connection, which inlet connection may also be fitted with a complementary dripless hose end-coupling 104. In addition or as an alternative to the flexible coaxial hose 103 described herein, other flexible hard-piping conveying connections may be used, including multiple single pipes or coaxial piping with swivel joint connections. However, a flexible coaxial hose 103 and coupling 104 as described herein is advantageous in that it provides needed flexibility to accommodate a wide range of vehicle-to-filling control console spatial arrangements, and further can use only a single conveying connection at the vehicle's filling site to accommodate both fuel filling and off-loading operations. During fuel filling, the solid-state hydrogen carrier can be transported within the hose's 103 inner pipe while the motive gas is vented from the fuel storage vessel 110 back to the rehydrogenator 200 through the outer annular conduit of the coaxial hose 103. Coaxial hose 103 may be composed of any combination of suitable elastomeric and/or other materials, including but not limited to flexible metal liners or resin coatings, such that low hydrogen gas permeability and excellent solid particle erosion resistance is attained.

During vehicle fueling, the solid-state carrier fuel discharges from the coaxial fuel hose 103 and coupling 104 and enters the fuel storage vessel 110 through a valve 110A. As shown in FIGS. 3, 4 and 7, and explained in greater detail herein, fuel storage vessel 110 includes an outer shell, and an inner container which contains the solid-state fuel. The inner container is typically constructed from a suitable porous medium such that the solid carrier is retained within this inner container while the motive gas easily passes through the container wall into the annular space between the outer shell and the inner container. The motive gas, as vent gas, is then routed out of the fuel storage vessel via outlet valve 110B, through the outer annular chamber of the flexible coaxial fuel hose 103 and back to rehydrogenator 200. Optionally, the route back to the rehydrogenator passes through the control console 105.

### Example of Spent Fuel Off-Loading.

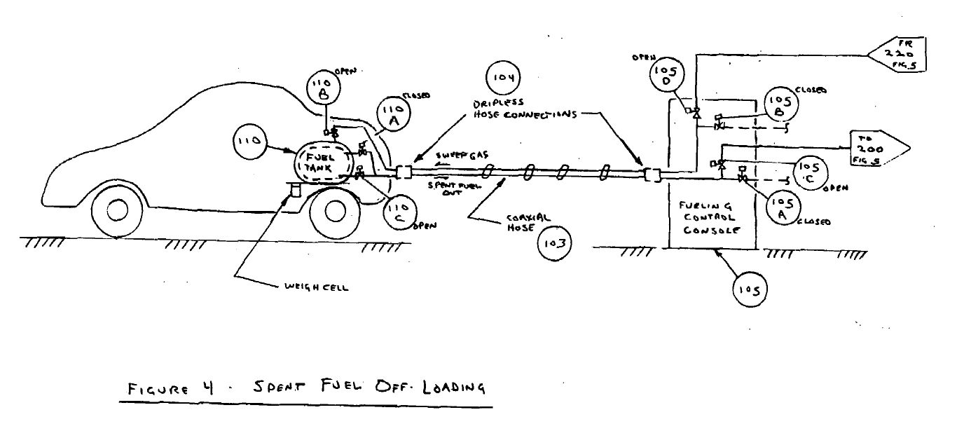

As shown in FIG. 4 and FIG. 5, spent solid-state solid carrier is removed from the vehicle's fuel storage vessel 110 via a continuous dilute-phase conveying system. Cooled hydrogen gas from the discharge of the rehydrogenator compressor 210 is piped to the fueling control console 105 where it is routed via the outer annular conduit of flexible coaxial hose 103 to the vehicle fuel storage vessel 110 through valve 110B. The hydrogen gas typically passes through the porous wall of the inner container and sweeps solid-state carrier particles into the outlet port of the vessel, through outlet valve 110C and into coaxial hose 103. Typical solid particle conveying velocities range from about 7.5 m/sec to about 10 m/sec at conveying pressures between about 1 barg to about 2 barg. The spent solid-state carrier is transported in a continuous dilute phase through the inner pipe of coaxial hose 103, through fueling control console 105, thereby returning to rehydrogenator 200, such as by use of a fluidized bed dip tube and backflow seal arrangement. Exemplary fluid bed backflow seal arrangements include, but are not limited to, the following designs: a) flapper valve, b) J-valve, c) L-valve, and d) fluid-seal pot, as described in the publication Perry, R., et al., “Perry's Chemical Engineers' Handbook”, 7^{th} Ed., McGraw-Hill, NY, pp. 17/12-17/13 (1997).

### Example of Fueling Control Console Operation and Logistics.

As shown in FIG. 3 and FIG. 5, the refueling process requires two sequential operations, spent fuel discharge and fresh fuel loading, to successfully complete the refueling operation. Fueling control console 105 manages both operations via a computer program which automatically aligns the loading/off-loading valves 110A, 110B, and 110C to discharge spent fuel to the rehydrogenator 200 and then realigns these automatic valves 110A, 110B, and 110C to charge the required weight of fuel into the vehicle's fuel storage vessel 110.

As shown in FIG. 4, during spent fuel discharging from the vehicle fuel storage vessel 110 is initiated upon inserting coaxial fueling hose 103 into the vehicle fuel storage tank inlet connection. An electronic signal from fueling control console 105 opens valves 105C and 105D and closes valves 105A and 105B. Likewise, vehicle fuel storage vessel gas vent valve 110B and outlet valve 110C are opened and vehicle fuel storage vessel inlet valve 110A is closed. The cooled hydrogen gas flow from rehydrogenator compressor 210 sweeps the spent carrier out of the storage vessel back to rehydrogenator 200. The hydrogen that was heated to some extent in the rehydriding process is cooled to about ambient temperature. The partial pressure of hydrogen in this sweep gas should be commensurate with the H₂ equilibrium pressure of the carrier material—to preclude either a charge or discharge of hydrogen from the solid carrier.

When the fuel storage vessel is empty, the fuel storage vessel weigh-cell electronically signals fueling control console valves 105C and 105D to close followed by closure of fuel storage vessel valves 110B and 110C. Fuel storage vessel 110 is now prepared for refueling sequence initiation. Typical weigh cell technologies include, but are not limited to, compression, bending beam and shear beam. Other suitable weighing and/or scale devices may be utilized within the scope of this invention.

As shown in FIG. 3, the refueling operation is automatically initiated from the fueling control console with an electronic signal to open valves 105A and 105B and close valves 105C and 105D. Likewise, vehicle fuel storage vessel inlet valve 110A and motive gas vent valve 110B are opened and spent solid carrier off-loading valve 110C is closed. The dense-phase pneumatic transfer system then systematically discharges the required number of weighed solid-state carrier fuel pulses from dense-phase transport vessel 101. Carrier solids may be metered into the vehicle fuel storage vessel by various methods, depending on the dense-phase pneumatic transport system employed. Typical fuel pulse methods include, but are not limited to, pulsed feed (e.g., batch charging) or continuous feed which is regulated via cumulative weight and/or other mass-flow measurement methodologies.

The weight of fuel to be charged to the vehicle is easily determined via weigh-cells or other weighing or measuring devices affixed to the vehicle storage vessel and the dense-phase transport vessel. These data are input to the fueling control console 105 which determines the precise number of dense-phase transport pulses to charge into the vehicle storage vessel 110. When the pre-selected weight of solid carrier fuel is discharged into fuel storage vessel 110, an electronic signal from fueling control console 105 sequentially closes valves 110A and 110B and then valves 105A and 105B.

### Example of Solid-State Carrier Rehydrogenation.

As shown in FIGS. 4-6, spent solid-state carrier is rehydrated in rehydrogenator 200 where hydrogen gas is intimately mixed with the solid-state carrier in a dense phase gas fluidization process. Other fluid bed technologies may be employed to affect the required mass transfer. Alternative fluid bed designs may include but are not limited to: a) circulating fluid bed, b) moving bed, c) co-current dense phase flow, and d) venturi fluid bed, as described in the publication Perry, R., et al., “Perry's Chemical Engineers' Handbook”, 7^{th} Ed., McGraw-Hill, NY, pp. 17/1-17/8 (1997), which publication is herein incorporated by reference in its entirety.

The “refilling” or re-hydrogenation of the carrier is done by contacting the carrier in a fluidized form with hydrogen, the hydrogen itself acting (with an added inert gas if desired) as the fluidizing medium. The “Physical” H₂ sorbents are expected to rapidly take up the hydrogen; H₂ sorption rates will generally be slower for the “chemical” sorbents e.g. metal hydrides. Publications by A. Bernis et al, Entropie N^{o} 116/117, p 58-63,1984; C. H. Luo et al, J. Chem. Eng. of Japan, 31 (1), p 95-102, 1998; and A. Bernis et al, Informations Chimie no 198, p 89-92 (1980) describe processes for preparing a metal or metal-alloy hydrides by reaction of the finely divided metal alloy with hydrogen in a fluidized bed. Inherent advantages are improved kinetics because of the small particle size, good reaction control and a more facile heat transfer. In all cases H₂ sorption will be accompanied by a release of heat from the rehydrogenation reactor (the ΔH of Equation 2). This heat value may be recovered for heating/cooling or power generation.

Fluidization is achieved by passing gaseous hydrogen through gas distributor 202 of the rehydrogenator 200 with sufficient velocity and pressure to suspend the solid-state carrier in a stable state of fluidization. Typical fluidized bed distributor designs vary based on inlet gas solids concentration. For clean inlet gas, designs may include tuyeres, bubble caps or other mechanical devices installed across a distributor plate of the distributor 202 to ensure good gas distribution. When both solids and gases pass through the distributor plate, more open structures are useful such as perforated plate, concentric rings, T-bar grids, etc. Within the scope of this invention the type of distributor employed depends on the solids concentration of the feed gas stream which varies based on the efficiency of the gas-solids separation equipment utilized.

The fluidized bed depth is maintained via dip pipe 207 which provides sufficient particle residence time within the fluidized bed to achieve about 6 weight % to about 12 weight % adsorption of hydrogen gas onto the carrier. Bed depths of about 0.5 meter to about 15 meters are maintained, and superficial gas velocities within the rehydrogenator are maintained in the range of about 0.5 ft/sec to about 10 ft/sec, or as otherwise required to ensure adequate fluidization of the solid-state carrier. Rehydrogenator 200 operating pressures and temperatures range between about 1 atm to about 50 atm and about 10 C to about 200 C depending upon the physical properties and adsorption isotherms for the chosen solid-state carrier. Hydrogen gas discharges from rehydrogenator 200 via solid-gas separator device 203 which removes entrained solid particles from the exiting gas stream and returns these solids to the fluid bed, such as through a fluidized bed dip tube and backflow seal arrangement. Cyclones, bag filters or other suitable gas-solid separating devices may be used. A small purge stream is removed from the rehydrogenator 200 recirculation line, such as by a valve controlled purge line 205 to control and remove impurities such as oxygen, nitrogen, etc. The impurity material is disposed of via incineration, reprocessing or other suitable manner. Fresh hydrogen is supplied by a hydrogen supply 206 communicably supplied to the rehydrogenator 200, such as a recirculation stream to replace hydrogen adsorbed by the solid-state carrier as well as that lost through the purge stream through purge line 205. Hydrogen gas leaving solid-gas separator 203 is recirculated via hydrogen gas recirculation compressor 210. Suitable gas recirculation equipment may include, but is not limited to: a) single- or multiple-stage reciprocating compressor, b) single- or multiple-stage oil flooded screw compressor, and c) multi-stage integral gear centrifugal compressor.

Heat of adsorption is removed from the process at a rate of about 5 Kcal/mol hydrogen to about 10 Kcal/mol hydrogen by recirculation gas cooler 220 using cooling water or other suitable cooling medium such as ambient air. Other suitable heat removal methodologies may be employed to remove heat from the process such as but not limited to external heat integration with other process streams, heat removal devices internal to the rehydrogenator, among other methods. Other suitable cooling mechanisms may be employed, including but not limited to: a) cooling surfaces internal to the fluid bed such as coils, fins, tubes, etc; b) liquid hydrogen injection whereby the latent heat of vaporization compensates for the heat of adsorption; c) solids circulation across external cooling surfaces such as coils, fins, tubes, etc; d) gas circulation through suitable heat exchangers (coils, fins, tubes, etc) to cool the inlet hydrogen feed. Further information on such cooling systems is provided in the publication: Perry, R., et al., “Perry's Chemical Engineers' Handbook”, 7^{th} Ed., McGraw-Hill, NY, pp. 17-10 (1997).

Fresh solid-state carrier can be added to rehydrogenator 200 via a suitable method such as illustrated in FIG. 5. In this method, solid-state carrier is delivered to fresh solid-state carrier storage vessel 300 via a bulk trailer transporter and off-loaded into storage vessel 200 via pneumatic conveying. Typically, the inert gas or appropriate mixture of H₂ and an inert gas is used as the conveying gas and is discharged to atmosphere through gas-solid separator 301 or returned to the bulk trailer transporter. Gas-solid separator devices may include, but are not be limited to, filter bag receiving bins or cyclonic devices (internal, external or internal/external to the fluid bed device), as described in the publication: Center for Chemical Process Safety, “Guidelines or Safe Handling of Powders and Bulk Solids”, CCPS Publication G-95, AlChE Publications, NY, pp. 614-640 (2005).

When the level of hydrogenated solid-state carrier fuel in rehydrogenator storage vessel 201 falls below a pre-defined level, fresh solid-state carrier is discharged from storage vessel 300 via rotary feeder valve 302 into a dilute-phase pneumatic conveying system. Gas-solid separator 204 separates the solid-state carrier particles from the conveying gas stream and the fresh solid-state carrier is fed into the rehydrogenator fluid bed through a typical fluidized bed dip tube and backflow seal arrangement. The dilute-phase conveying gas exits gas-solid separator 204 and is cooled by recycle gas cooler 310 to remove heat of compression resulting from blower 320 in this closed-loop dilute-phase transfer system design. Recycle gas cooler technologies may include, but are not be limited to, a) shell and tube heat exchanger, b) fin-fan air cooling devices, or c) other heat exchanger designs appropriate for gas cooling. Nitrogen gas or other suitable conveying gas can be utilized to transport the fresh carrier to rehydrogenator 200. Use of nitrogen or other inert gas in this service provides an inert barrier between both the fresh solid-state carrier storage vessel 300 and bulk delivery container and the hydrogen atmosphere in the rehydrogenator system.

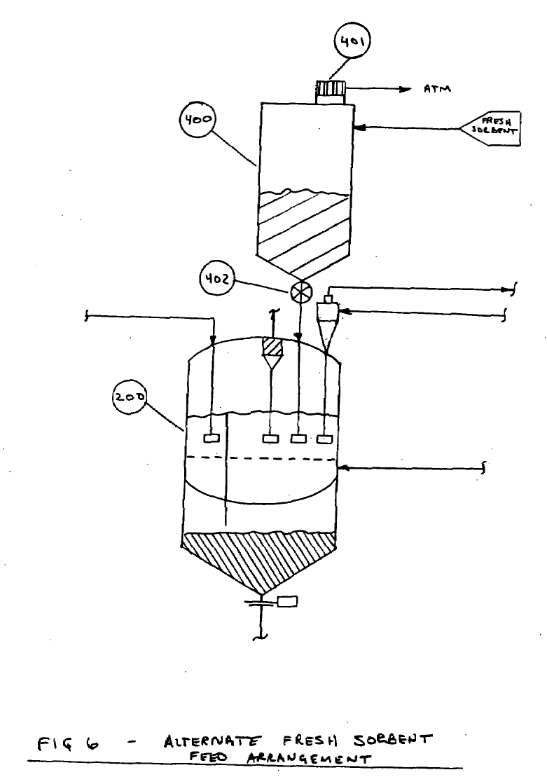

An alternative fresh solid-state carrier feed arrangement is illustrated in FIG. 6 whereby a second embodiment of a fresh solid-state carrier storage vessel 400 is located above rehydrogenator 200 such that the solid-state carrier is discharged directly into the rehydrogenator via gravity feed through rotary discharge valve 402. Other solids discharging devices may be utilized, including but not limited to, dump valve arrangements, screw feeders, and slide gate valves, as described in the publication: Center for Chemical Process Safety, “Guidelines or Safe Handling of Powders and Bulk Solids”, CCPS Publication G-95, AlChE Publications, NY, pp. 733-744 (2005). Fresh solid-state carrier is delivered to storage vessel 400 in a similar manner as previously described above for storage vessel 300. In the illustrated embodiment, the vessel 400 includes a solids separator 401, similar to solids separator 301.

### Exemplary Vehicle Storage Vessel Design.

The embodiment of the invention illustrated in FIGS. 3 thru 6 comprises an inventive vehicle storage vessel design and appurtenances illustrated in FIG. 5. The fuel storage vessel 500 is constructed in a “tank within a tank” configuration such that an annular space is created between the outer vessel wall and the inner vessel 501. Outer vessel 500 is constructed of suitable materials such as metal or other structurally integrous media, including carbon fiber, plastic, fiberglass, etc., that are capable of containing internal pressures in the 1 barg to 50 barg range as well as meeting such DOT or other impact requirements that may be imposed by regulations. The inner vessel 501 is constructed from a suitably porous material such as perforated metal, porous ceramic, sintered metal or other similar gas permeable structurally integrous media whereby the solid-state carrier is contained within the inner vessel 501 and hydrogen or other gases easily pass through the vessel wall into the annular area between the two vessels. The vessel shape and volumetric capacity are conformable to a wide range of spatial and volumetric requirements. Typical fuel storage vessel volumes suitable for motor vehicle use range from 40 liters to 75 liters but are not limited to this range. Likewise, vessel shape is not limited to that depicted in FIGS. 3-5 and FIG. 7.

The fuel storage vessel 500 is fitted with three inlet/outlet connections having operational nozzle and valve assemblies 502, 503, 504 to selectively permit fresh hydrogenated solid-state carrier to be loaded into the internal vessel during dense-phase conveying, as well as off-loading of dehydrogentated carrier from the internal vessel during dilute-phase conveying, as discussed in previous paragraphs. The loading nozzle and valve assembly 502, and the unloading nozzle and valve assembly 504 extend from the inner vessel wall and protrude through the annular space between the porous inner wall 501 and solid outer wall of the vessel 500. That configuration provides for in-flow of hydrogenated solid-state carrier through loading valve 502, and for discharge of dehydrogenated carrier from the inner vessel through unloading nozzle 504, each nozzle 502, 504 feeding the inner chamber of coaxial hose 103 through coupling 104. Nozzle 503 provides communicable access with the outer annular chamber of the hose 103 to the annular space for dense-phase motive gas venting to the hose 103 and alternately for hydrogen sweep gas inflow from the outer annular chamber of hose 103 during solid-state carrier off-loading. Hydrogen feed nozzle 506 allows released gaseous hydrogen fuel to be discharged from the fuel storage vessel to the engine or other hydrogen consumption device, and may be fitted with a suitable micro porous filter to entrap any solid-state carrier particles entrained in the gaseous exit stream.

Unloading nozzle 504 is designed and shaped to facilitate discharge of the solid-state carrier from the inner vessel 501. As depicted in FIG. 7, an eccentric nozzle configuration is used whereby the diameter ratio of the nozzle's opening into the inner vessel 501 to the outlet pipe connection typically ranges between 2 and 4, however, other ratios are not excluded. To allow complete removal of all solid-state carrier, the bottom of the eccentric nozzle is flush-mounted with the bottom of the inner vessel 501. At this location the inner vessel wall transitions smoothly into the nozzle structure to reduce frictional losses when discharging the solid carrier. Small aerating jets 505 are fabricated around the entire smooth transition zone at nozzle 504 to break up and assist the initial discharge of solid-state carrier from the inner vessel. During solids discharge hydrogen sweep gas flow is initially directed to these jets via a graduation in open area of the inner vessel's porous wall. By providing greater inner vessel wall open area near outlet nozzle 504 versus the remainder of the vessel wall area, sweep gas flow is preferentially directed to the solids discharge zone and into the aerating jets. The required degree of open area gradation in the inner vessel wall varies with solid-state carrier size, density and flowability characteristics. With more dense and/or less flowable solid-state carrier material, greater gas flow is required to be directed to the nozzle's aerating jets, thus resulting in a greater open area gradation across the inner vessel surface. It is desirable to provide sufficient open area across the entire inner vessel wall area to ensure sufficient removal of solid-state carrier.

Release of hydrogen gas from the solid-state carrier is achieved by heating the solid-state carrier contained within inner vessel 501 or reducing the H₂ pressure by a withdrawal of gas. Heat is supplied to the fuel storage vessel through any one or more of suitable heat exchange mechanisms, including but not limited to internal heating coils 507, external heating coils 508, external electric resistance heating strips 509, combinations thereof, as well as other known heating apparatus and methods. By way of further example, various vehicle heat sources may be utilized, including waste heat from internal combustion engines, electric current, among other heat sources Heat control is provided to regulate the solid-state carrier bulk temperature and concomitant hydrogen generation To conserve heat loss, the fuel storage vessel is fully encased in an insulating jacket 510 which is composed of suitable material to meet all regulatory requirements for flammability, thermal resistance and impact resistance.

In order to monitor the transfer and/or exchange of solid carrier, whether spent or fresh, the system and methods may utilize at least one device as means to measure at least one chemical or physical property of the carrier. The measured property can be correlated to product content in the carrier. For example, product content may be determined by measuring fresh or spent density and comparing the results to those defined in a pre-established density curve. In general, each carrier may have its own pre-established quality control curves. In another example, product content may be monitored in order to communicate to the user the quantity/quality of product in the carriers that are being loaded/offloaded. Other methods may be used, such as but not limited to, for example, UV and IR sensors or refractive index based measurements as was mentioned above. The ability to measure product content can be useful since a carrier may deteriorate with time and may gradually lose product carrying capacity. Similar device may be installed at a user as an onboard device and may be used as, for example, a product content monitoring gauge. A product content monitoring device may be based on measurements of, for example, physical, chemical, electrical, optical, or any other properties of the carrier with or without product contained. In addition, the device may be constructed utilizing differential or absolute measurement techniques. For example, measuring density of the carrier with product once per established unit time, for example, every five minutes and comparing it to a standard pre-established density data for a given carrier may provide the user with information on amount of product left in the carrier or on how well product is removed by a product removal device, for example dehydrogenation unit. Different computing or display systems may be employed to integrate obtained information into a format convenient for a specific user.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for dispensing a solid fuel carrier to a recipient vehicle, the apparatus comprising:
a solid-state, particulate hydrogen carrier material, the material selected reversibly adsorb hydrogen and release hydrogen;
a rehydrogenator configured to adsorb hydrogen onto the carrier to form a hydrogenated carrier;
a dense-phase pneumatic transport system configured and disposed for conveying the hydrogenated carrier to a user vehicle:
a user vehicle configured and disposed for receiving and storing the hydrogenated carrier, and for removing hydrogen from the hydrogenated carrier to form an at least partially dehydrogenated carrier; and
a dilute-phase pneumatic conveying system configured and disposed for removing the at least partially dehydrogenated carrier from the user vehicle and returning the carrier to the rehydrogenator.

2. The apparatus of claim 1, wherein the user vehicle further comprises a fuel storage vessel configured and disposed for receiving the hydrogenated carrier and at least one motive gas of the dense-phase pneumatic transport system, and for separating the hydrogenated carrier material from the at least one motive gas.

3. The apparatus of claim 2, wherein the fuel storage vessel further includes means for determining the amount of carrier in the fuel storage vessel.

4. The apparatus of claim 2, wherein the fuel storage vessel comprises an inner vessel and an outer vessel, the inner vessel and outer vessel separated by a porous inner vessel wall configured to permit the passing of a motive gas from the inner vessel to the outer vessel while substantially preventing the passing of carrier material from the inner vessel to the outer vessel.

5. The apparatus of claim 4, wherein the dense-phase pneumatic transport system is selected from the group consisting of simple pressure systems, pulse phase systems, bypass systems, and combinations thereof.

6. The apparatus of claim 5 wherein the dense-phase transport system utilizes at least one motive gas selected from the group consisting of hydrogen, argon, nitrogen and helium.

7. The apparatus of claim 6, wherein the dense-phase pneumatic transport system further comprises at least one dense-phase transport vessel configured and disposed to pressurize and at least partially fluidize the hydrogenated carrier, and to discharge the pressurized and at least partially fluidized hydrogenated carrier into a conveying line for transport to the inner vessel of the fuel storage vessel of the user vehicle.

8. The apparatus of claim 7, further comprising a fueling control console configured and disposed to control the flow of pressurized and at least partially fluidized hydrogenated carrier through the conveying line to the user vehicle.

9. The apparatus of claim 8, wherein the conveying line further comprises a coupling that is compatible with an inlet connection of the user vehicle to form a substantially airtight connection for conveying the hydrogenated carrier to the inner vessel of the fuel storage vessel.

10. The apparatus of claim 9, wherein the conveying line comprises the inner annular chamber of a coaxial hose, the coaxial hose having a separate outer annular chamber that is configured and disposed to remove motive gas substantially free of carrier material from the outer vessel of the fuel storage vessel.

11. The apparatus of claim 10, wherein the dilute-phase pneumatic transport system is selected from the group consisting of positive pressure systems, negative pressure systems, and combined positive-negative pressure systems.

12. The apparatus of claim 11, wherein the conveying line further comprises a coupling that is compatible with an outlet connection of the user vehicle to form a substantially airtight connection configured for conveying motive gas from the outer annular chamber of the coaxial hose to the outer vessel of the fuel storage vessel, through the inner vessel wall and into the inner vessel, thereby sweeping dehydrogenated carrier from the inner vessel into the inner annular chamber of the coaxial hose for return to the rehydrogenator.

13. The apparatus of claim 12, wherein the fueling control console is configured and disposed to operate valves located in any of the dense-phase pneumatic transport system, dilute-phase pneumatic transport system, and user vehicle so as to selectively control the flow of hydrogenated carrier, motive gas, and dehydrogenated carrier.

14. The apparatus of claim 13, wherein the fuel storage vessel further comprises means for heating the hydrogenated carrier to a temperature sufficient to release adsorbed hydrogen to convert the hydrogenated carrier to an at least partially dehydrogenated carrier.

15. The apparatus of claim 14, wherein the means for heating the hydrogenated carrier are selected from the group consisting of: internal heating coils, external heating coils, electric resistance heating strips, and waste heat from internal combustion engines or other vehicle systems, and combinations thereof.

16. The apparatus of claim 13, wherein the coupling comprises an inner coupling portion divided from an outer coupling portion by a non-porous inner wall, the inner coupling portion communicably connected to the inner annular chamber of the coaxial conveying line, the outer coupling portion communicably connected to the outer annular chamber of the coaxial conveying line.

17. The apparatus of claim 16, wherein the fuel storage vessel includes a loading nozzle configured and disposed to receive and evenly distribute particulate hydrogenated carrier material at a predetermined flow rate and pressure during a first refueling operation, and wherein the fuel storage vessel further includes an unloading nozzle configured and disposed to collect particulate dehydrogenated carrier material at a predetermined flow rate and pressure during a second refueling operation.

18. A method of refueling a user vehicle, the user vehicle configured to utilize hydrogen as a fuel, the method comprising the steps of:
providing an apparatus for conveying a hydrogenated carrier material to a user vehicle, the apparatus comprising the apparatus of claim 1,
selecting a first refueling mode using the fueling control console; and
operating the apparatus so as to dispense the hydrogenated carrier to the internal vessel of the fuel storage vessel of the user vehicle.

19. The method of claim 18, further comprising the steps of:
removing hydrogen from the hydrogenated carrier to form an at least partially dehydrogenated carrier;
selecting a second refueling mode using the fueling control console; and
operating the apparatus so as to dispense motive gas to the outer vessel of the fuel storage vessel, through the porous internal wall, and into the inner vessel in sufficient quantity and at sufficient pressure so as to cause the dehydrogenated hydrogenated carrier to exit the inner vessel for return to the rehydrogenator.

20. The method of claim 19, further comprising the steps of:
operating the rehydrogenator to convert the dehydrogenated carrier to a rehydrogenated carrier.
